(19) United States
(12) Patent Application Publication
(10) Pub. No.: US 2017/0370790 A1
(43) Pub. Date: Dec. 28, 2017

(54) ESTIMATING DYNAMIC THRUST OR SHAFT POWER OF AN ENGINE

(71) Applicant: Sikorsky Aircraft Corporation, Stratford, CT (US)

(72) Inventors: Eric Nelson Hettler, Rochester, NY (US); Carl Palmer, Pittsford, NY (US)

(21) Appl. No.: 15/548,695

(22) PCT Filed: Dec. 3, 2015
(86) PCT No.: PCT/US15/63607

§ 371 Date: Aug. 3, 2017

Related U.S. Application Data
(60) Provisional application No. 62/111,939, filed on Feb. 4, 2015.

(51) Int. Cl. G01L 5/13; F01D 21/00

(52) U.S. Cl. CPC G01L 5/133; F01D 21/003; F05D 2260/81; F05D 2220/323

(57) ABSTRACT

A measuring system is provided that includes a turbine engine thrust estimator that computes “virtual measurements” of dynamic engine thrust and other parameters of interest from test cell data in a very short amount of time. The measuring system ‘tunes’ a user's engine model, in a numerical propulsion system simulation, by optimizing system biases and health parameters to match the sensor outputs of a set of steady state data points across the operating range. The tuned model is then utilized by the measuring system to create a constant gain extended Kalman filter that is added directly within a code of the numerical propulsion system simulation. Results, including thrust, from the numerical propulsion system simulation with Kalman filter are then presented as ‘actual’ corrected data.

### STATEMENT REGARDING FEDERALLY SPONSORED RESEARCH AND DEVELOPMENT

This invention was made with government support with the United States Navy under Contract No. N68335-11-C-0373. The government therefore has certain rights in this invention.

### BACKGROUND

The disclosure relates generally to estimating dynamic thrust or shaft power of an engine, and more specifically, to a calculation methodology that utilizes live and/or recorded test stand data, along with a hybrid set of techniques, to estimate a value for thrust or shaft power usable as an ‘actual’ dynamic value in lieu of having a reliable measurement.

Thrust or shaft power during dynamic maneuvers is a critical measurement in engine acceptance and development tests. This is especially true for military engines that undergo quick transients. Unfortunately, in some instances where dynamic or transient thrust is important, a measured signal from a test cell may be too noisy or error prone to provide meaningful information. Estimating dynamic thrust is a challenging task due to the complex dependency of thrust on the engine's health condition and other factors, such as test stand vibrations and measurement uncertainty, and current methodologies do not overcome these challenges.

### SUMMARY

According to one embodiment of the present invention, a measuring system for computing a dynamic thrust is provided where the measuring system comprises a processor and a memory storing instructions thereon, the instructions executable by the processor to cause the measuring system to perform calibrating of an engine model by utilizing steady state engine data based on multiple operating conditions to produce a calibrated model and estimating the dynamic thrust by inputting dynamic state engine data into the calibrated model.

In another embodiment or in combination with the above embodiment, the calibrating of the engine model can be optimized based on a hybrid heuristic optimization algorithm.

In another embodiment or in combination with any above embodiment, with respect to the calibrating of the engine model, the instructions can be further executable by the processor to cause the measuring system to perform a determining by a non-linear least squares heuristic whether an error has converged to a minimum value.

In another embodiment or in combination with any above embodiment, when the error has not converged to the minimum value, the non-linear least squares heuristic can change at least one selected tuner value to minimize the error.

In another embodiment or in combination with any above embodiment, with respect to the estimating of the dynamic thrust, the instructions can be further executable by the processor to cause the measuring system to perform a dynamic calibration tuning of the calibrated model using a constant gain extended Kalman filter and the dynamic state engine data.

In another embodiment or in combination with any above embodiment, the measuring system can be communicatively coupled to a test cell and can receive the steady state engine data and the dynamic state engine data from the test cell.

In another embodiment or in combination with any above embodiment, the calibrating of the engine model by utilizing the steady state engine data based on the multiple operating conditions to produce the calibrated model can comprise additional weighting factors based on which of the multiple operating conditions are being processed by the measuring system.

In another embodiment or in combination with any above embodiment, the measuring system can further comprise performing an analysis to automatically identify which operating point of the multiple operating conditions is the weakest.

In another embodiment or in combination with any above embodiment, the measuring system can further comprise generating optimization parameters and tuner limits across an entire range of uncertainties.

According to another embodiment of the present invention, a method for computing by a computing device a dynamic thrust is provided where the method comprises calibrating of an engine model by utilizing steady state engine data based on multiple operating conditions to produce a calibrated model and estimating the dynamic thrust by inputting dynamic state engine data into the calibrated model.

In another embodiment or in combination with any above embodiment, the calibrating of the engine model can be optimized based on a hybrid heuristic optimization algorithm.

In another embodiment or in combination with any above embodiment, the method can further comprise determining by a non-linear least squares heuristic whether an error has converged to a minimum value.

In another embodiment or in combination with any above embodiment, when the error has not converged to the minimum value, the non-linear least squares heuristic can change at least one selected tuner value to minimize the error.

In another embodiment or in combination with any above embodiment, the method can further comprise dynamic calibration tuning of the calibrated model using one of an extended Kalman filter, a constant gain extended Kalman filter, and a set of scheduled constant gain Kalman filters.

In another embodiment or in combination with any above embodiment, the computing device can be communicatively coupled to a test cell and the method can further comprise receiving, by the computing device, the steady state engine data and the dynamic state engine data from the test cell.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a vehicle environment for employing a measuring system;

FIG. 2 illustrates a process flow of a measuring system;

FIG. 3A illustrates another process flow of a measuring system;

FIG. 3B illustrates another process flow of a measuring system; and

FIG. 4 illustrates a processing system with a measuring system installed thereon.

### DETAILED DESCRIPTION

As indicated above, current methodologies for deriving a measured signal from a test cell are too noisy or error prone to provide meaningful information and do not overcome the complex dependency of thrust on the engine's health condition and other factors. Thus, what is needed is a system, method, and/or computer program product configured to estimate dynamic thrust or shaft power of an engine.

In general, embodiments of the present invention disclosed herein may include a measuring system, method, and/or computer program (“measuring system” herein) product that estimate dynamic thrust or shaft power of an engine via a calculation methodology that utilizes live data, recorded test stand data, and/or on-aircraft data (e.g., the measuring system can be installed on the aircraft for monitoring purposes, such as implemented and tested on a simulated two spool turbojet engine, plus an actual two spool turbojet engine, with recorded test cell data), along with a hybrid set of techniques. In this way, the estimated thrust or shaft power is usable as an ‘actual’ dynamic value in lieu of having a reliable measurement.

For example, the measuring system includes a turbine engine thrust estimator that computes “virtual measurements” of dynamic engine thrust and other parameters of interest from test cell data in a very short amount of time. The measuring system ‘tunes’ a user's engine model, in a numerical propulsion system simulation, by optimizing system biases and health parameters to match the sensor outputs of a set of steady state data points across the operating range. The tuned model is then utilized by the measuring system to create a constant gain extended Kalman filter (CGEKF) that is added directly within the code of the numerical propulsion system simulation. Results, including thrust, from the numerical propulsion system simulation with Kalman filter are then presented as ‘actual’ corrected data.

The above measuring system is extremely elastic and flexible, for example, any numerical propulsion system simulation model for any gas turbine engine can be used. Further, the utilization of and tight integration with the numerical propulsion system simulation by the measuring system ensures that the results always preserve mass and energy, and are realistic from an engine performance point of view (i.e., the numbers will not break the laws of physics, for example, a compressor efficiency will not exceed 100%). The measuring system also includes the ability for a whole tuning process to ‘correct’ not just noisy test data, but also performance parameters within an actual numerical propulsion system simulation model of a user. The measuring system may employ a graphic user interface to lead users through each step of the process, such as matching the numerical propulsion system simulation variable names to signals in actual test cell data files, selecting ‘tuners’ (performance parameters, sensor errors), and selecting Kalman filter variables.

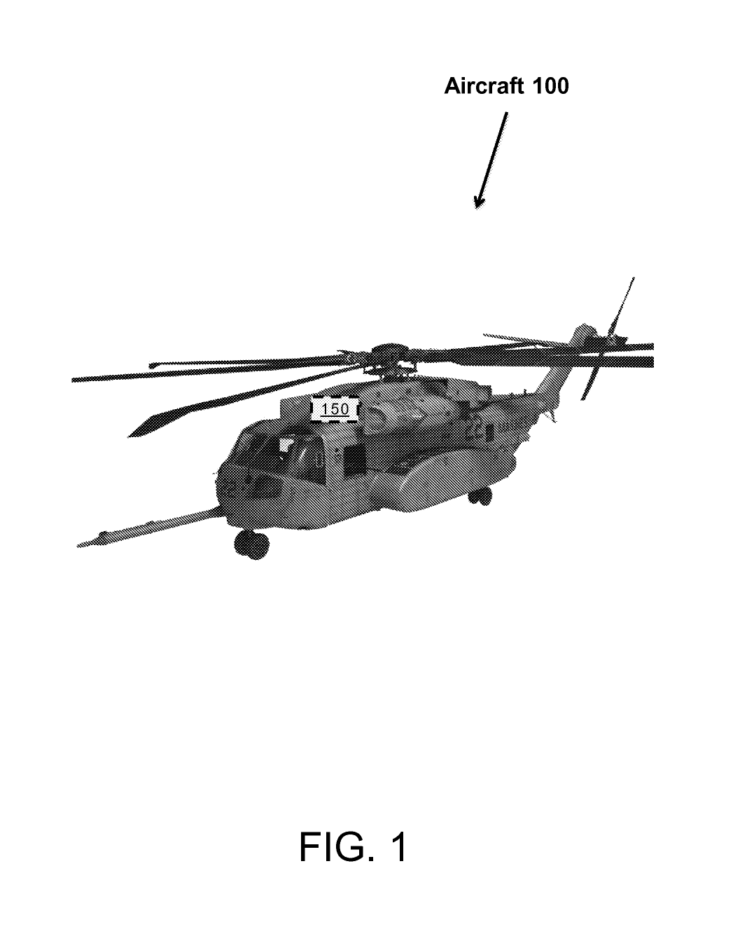

FIG. 1 illustrates a vehicle environment (e.g., a rotary wing aircraft 100) having a main rotor system. Although a particular rotary wing aircraft 100 configuration is illustrated and described in the disclosed embodiment, other vehicle environments, configurations, and/or machines, such as ground vehicles, jet aircraft, turbofan engines, high speed compound rotary wing aircraft with supplemental translational thrust systems, dual contra-rotating, coaxial rotor system aircraft, turbo-props, tilt-rotors and tilt-wing aircraft, and the like may also benefit from the embodiments described herein.

The measuring system 150, which can be integral to the rotary-wing aircraft 100 as shown or in communication with computing systems local to the rotary-wing aircraft 100, reliably and automatically measures sensor data and outputs dynamic thrust or shaft power via the calculation methodology. For example, the measuring system 100 can be in communication with a sensor sub-system that includes at least one sensor employed in an orientation with the one or more engines to detect and output sensor data. The sensor data of at least one sensor are further received as live test stand data and processed with recorded and/or model test stand data by a computing device of the measuring system 100, which is in communication with the sensor sub-system, that utilizes the calculation methodology and/or the hybrid set of techniques to solve for dynamic thrust or shaft power of the one or more engines.

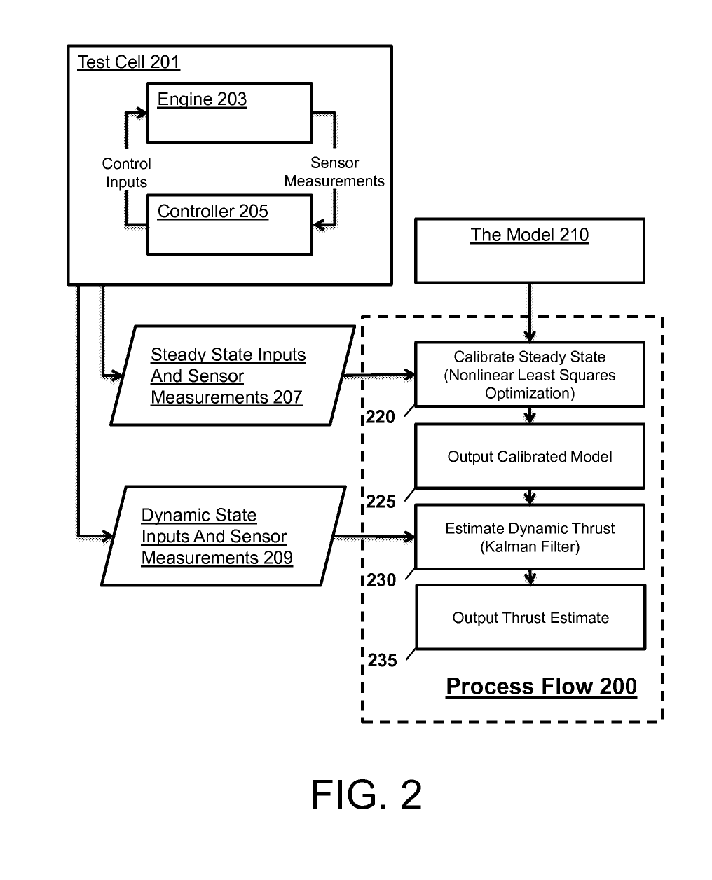

The vehicle environment and elements therein of the Figures may take many different forms and include multiple and/or alternate components and facilities. That is, while the rotary-wing aircraft 100 is shown in FIG. 1, the components illustrated in FIG. 1 and other Figures are not intended to be limiting. Indeed, additional or alternative components and/or implementations may be used. The measuring system 150 is described in greater detail with respect to FIG. 2.

FIG. 2 illustrates a process flow 200 of a measuring system 150 to properly estimate dynamic thrust of, for example, a gas turbine engine. FIG. 2 further illustrates a test cell 201 that includes an engine 203 (e.g., the gas turbine engine) outputting sensor measurements to a controller 205, which in turn inputs control inputs to the engine 205. Based on this communication between the engine 203 and the controller 205, the test cell outputs steady state inputs and sensor measurements 207 and dynamic state inputs and sensor measurements 209 to the process flow 200.

In addition, for the measuring system 150 to properly estimate dynamic thrust of the engine 205, an accurate model 210 of the engine 205 is employed. That is, even though conventional models may accurately predict a gas path of an engine, these conventional models output many forms of mismatches between the conventional models and actual engine data. For example, the mismatches may include but are not limited to sensor biases, actuator biases, component degradation, engine model parameter mismatches (e.g., improper modeling), and various test stand issues. Unfortunately, tuning all possible tuners is unfeasible due to the amount of mismatches and to the amount of control sensors present on the engine, each of which needs to be tuned to make the conventional models more accurate. In contrast to the conventional models, the model 210 is the most accurate model by being created via a two-step engine tuning process (e.g., the process flow 200).

The process flow 200 begins at block 220 where the model 210 is calibrated “offline” using only steady state data (e.g., the steady state inputs and sensor measurements 207) produced by the engine 205. For example, calibration of the model 210 can use the steady state engine data taken from multiple operating conditions. This increases observability and enables the estimation of more “tuners” during the calibration of the model 210 than could be done if using only one steady state point. A tuner is anything that can be altered in the model 210 to enable the model 210 to match measured data (e.g., the dynamic data from the engine). Examples of tuners include input, output, and parameter tuners. Input tuners can include error percentages (or absolutes) on input signals, such as inlet temperature, fuel flow, scheduled nozzle area, bleeds, etc. Output tuners can include measurement errors, such as errors on the temperatures or pressures inside the engine itself. Parameter tuners can include ‘health parameters,’ such as adders or multipliers to compressor efficiency or flows, turbine efficiencies, etc. All tuners can be assumed to be constant (either as an absolute or percent of point) across all operating conditions at this point in the calibration.

Further, the calibration of the model 210 is optimized based on a hybrid heuristic optimization algorithm (a.k.a. a heuristic nonlinear least squares optimization algorithm), simultaneous use of multiple operating conditions, and creation/utilization of a reduced order set. The hybrid heuristic optimization algorithm leverages user input or knowledge to identify a globally optimal set of tuners. The simultaneous use of multiple operating conditions is employed to increase a total number of measurements available for the calibration, which increases observability and can enable the use of more tuning parameters. The reduced order set can be a reduced order set of ‘combined’ tuning parameters that further increase the number of tuned parameters. In this way, a combined tuner would be a linear combination of items that may move together, e.g., based on assumptions. For example, it may be assumed that a turbine efficiency goes down 1% when a turbine flow area increases by 0.5%.

In addition, the calibration of the model 210 can comprise additional weighting factors based on which of multiple operating conditions are being processed. In this way, operating points at higher powers can be weighed more strongly, and the operating points where the model 210 may be weak or less accurate can be de-weighed. This could be done by a manual selection, either on individual measurements at each operating point or as an ‘adder’ for all measurements at each specific operating point. One example would be to reduce weighting factors by 10% for each 10% reduction from the full power point. Also, as a variant of this, an analysis could be performed that automatically identifies which operating point is the weakest. Further, a sensitivity study could be performed to identify an effect of de-weighing that point.

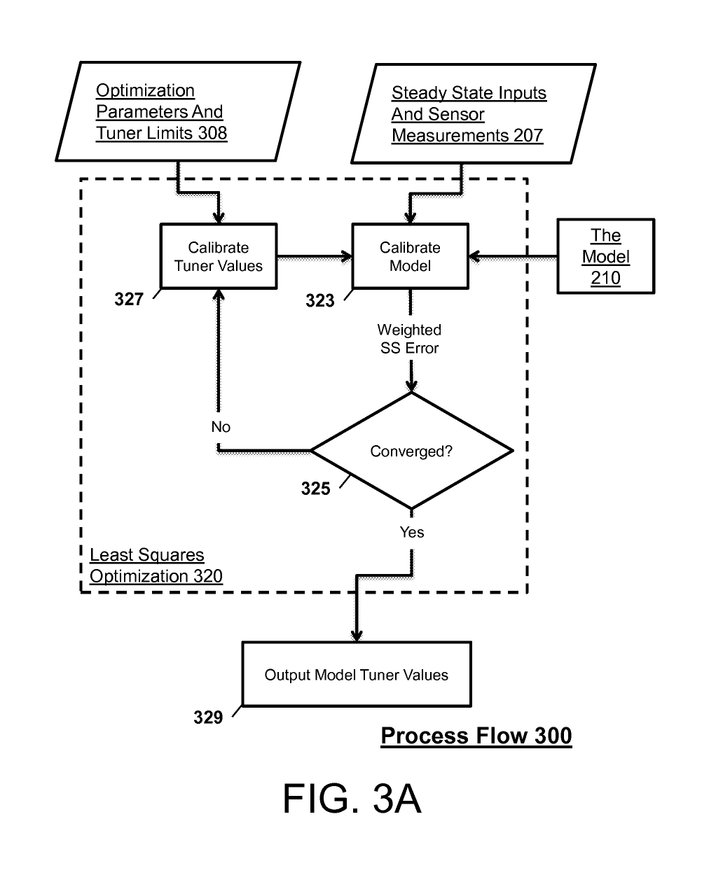

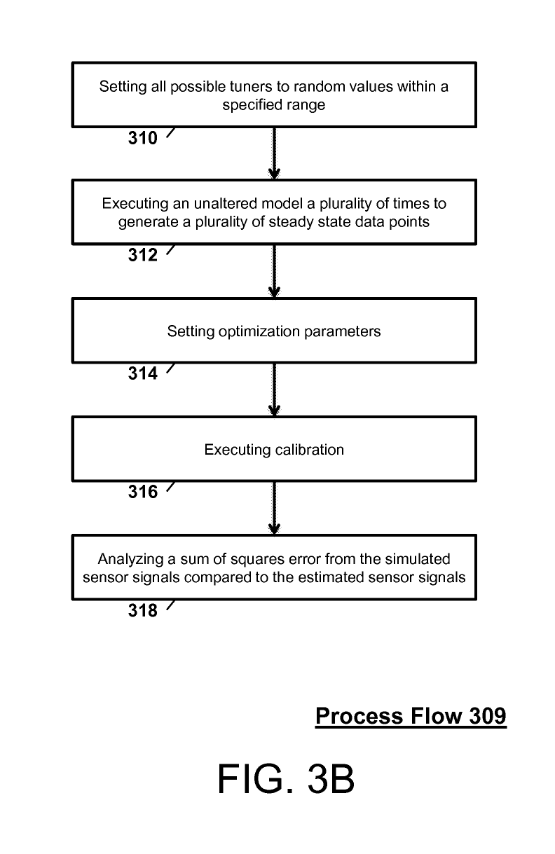

Block 220 of process flow 200 will now be described with reference to FIG. 3A and FIG. 3B. FIG. 3A illustrates a process flow 300 of the measuring system 150 for steady state tuning. The process flow 300 includes receiving the steady state inputs and sensor measurements 207 and (optionally) optimization parameters and tuner limits 308, which are utilized to calibrate the model 210, by a least squares optimization 320. Further, the received optimization parameters and tuner limits can be generated via a method that covers an entire range of uncertainties. For instance, as shown in FIG. 3B, this method or process flow 309 performs a Monte Carlo study on the unaltered engine model prior to calibration and using only simulated data to find the best optimization settings for a set of expected tuner ranges.

Turning to FIG. 3B, the process flow 309 begins at block 310 where all possible tuners are set to random values within a specified range. Then, at block 312, an unaltered model is run a number of times to generate a number of steady state data points (e.g., multiple operating conditions for each set of randomized tuners). Next, at blocks 314 and 316, optimization parameters are set and the calibration is run on all of the sets of data (e.g., once for each set of randomized tuners). At block 318, the sum of squares error from the simulated sensor signals compared to the estimated sensor signals is analyzed. Further, since the actual values of the randomized tuners are known, the process flow 309 can identify an amount of error on each estimated tuned parameter compared to the actual value. Thus, by refining the optimization inputs, the process flow 309 can identify values that are more globally optimal across the range of parameter mismatches.

In general, a non-linear least squares optimization 320 is an algorithm that, at block 323, calibrates the model 210. All of the recorded engine inputs (e.g., steady state inputs and sensor measurements 207) are run through the steady state engine model (e.g., the model 210) made in the numerical propulsion system simulation. The model 210 is run one time per operating condition. Further, estimated sensor output values from the model 210 are compared to measured sensor output values from the test cell 201 to create an error signal (e.g., for all operating points simultaneously). The error signal is weighted (e.g., Weighted SS Error) based on the signals deemed by the user to be most important, and summed together into a value to be minimized. Each tuner is perturbed, and the model 210 is run once for each perturbed reduced order tuner.

Then, at block 325, the non-linear least squares optimization 320 checks whether the error (e.g., the value to be minimized) has converged to a minimum value. If the error has not converged to the minimum value, the non-linear least squares optimization 320 changes, at block 327, all selected tuner values (e.g., optimization parameters and tuner limits 322) based on defined limits and weighting factors to minimize an error signal. The non-linear least squares optimization 320 allows for setting tuner boundaries (e.g. don't reduce compressor efficiency by more than 5%), ensuring a physically realistic tuned model in the end.

The non-linear least squares optimization 320 assumes that biases associated with all of the tuners remain (relatively) constant as a percent of point or as a percent of a nominal value for all operating conditions. That is, the non-linear least squares optimization 320 assumes that the engine is just ‘shifted’ from the numerical propulsion system simulation by the tuners across the whole operating space. Further, the non-linear least squares optimization 320 assumes the model is correct in how it changes as a function of operating conditions (load, temperature, etc.) and makes up for inconsistent modeling and sensor error mismatches. In terms of the weighting factors, the measured steady state thrust can be weighted as the strongest for all the signals to drive the tuning to match this parameter, which can be considered a key variable of interest when under dynamic calibration as described below. The weighting factors can also be altered such that certain operating conditions (e.g. near full power) can be weighed more strongly than at other conditions (e.g. at low power) where the base model may be weaker, or where it may be less important to match the data closely. This has the effect of loosening the constraint of a constant tuner factor for each variable across the range.

If the error has converged to the minimum value, the non-linear least squares optimization 320 “locks down” all tuner values in the model 210. In turn, as indicated by the YES Arrow leading to block 329, the non-linear least squares optimization 320 outputs the model tuner values of block 327, which enables a production of a ‘calibrated engine’ model. That is, returning to FIG. 2, the output tuner values are utilized to output the calibrated model, at block 225.

Then, at block 230, the calibrated model is tuned “online” (e.g., using real-time test cell 201 or recorded dynamic data) using the full transient data (e.g., the dynamic state inputs and sensor measurements 209). After the measuring system 150 estimates the thrust via the constant gain extended Kalman filter by using the dynamic state inputs and sensor measurements 209, the process flow 200 proceed to block 235 where the thrust estimate is outputted.

In general, dynamic calibration tuning can be accomplished using a regular extended Kalman filter, which is computationally expensive, a constant gain extended Kalman filter, or a set of scheduled constant gain Kalman filters (e.g., a linear model), which is scheduled based on operating condition (and less computationally expensive). The constant gain extended Kalman filter overcomes the substantial computational burden imposed by the traditional extended Kalman filter. In the constant gain extended Kalman filter, the filter gain K is a constant matrix designed at a representative operating point based on a linearized open-loop engine model. The selected operating point can be where one wants the best thrust estimate. Through experience, however, the matrix calculated at a relatively higher power, power condition produces a filter with adequate performance across the engine operating envelope.

The Kalman filter has two basic design parameters, the Q matrix and the R matrix. The Q matrix captures modeling uncertainty (e.g., in the form of an additive process noise). The R matrix in the Kalman estimator captures the measurement noise of the system. From the linear state space model and the Q and R matrices, a constant Kalman gain is calculated. When linearizing the model, engine parameters (e.g. health parameters) and input biases are treated as inputs to the calibrated model. The Kalman filter tuners are added in as extra states in the state space model. In order to make it so that all inputs to the Kalman filter hold equal or near equal weight in calculating the tuning parameters, all inputs, states and outputs of the linear model used in the Kalman gain calculation are scaled based on nominal values. Once the constant Kalman gain is calculated, it is implemented using the nonlinear engine model (i.e. the dynamic numerical propulsion system simulation model) from which the original linear state space model was created. Dynamic inputs from recorded test cell data are input into the nonlinear model. At each time step, the nonlinear engine model is allowed to converge using its own internal solver. A vector of error signals is then created using the nonlinear model outputs and the measured sensor data from the test cell 201. The error vector is multiplied by the constant gain creating the tuner derivatives that are then integrated at each time step using a trapezoidal integration. These integrated signals are then added back into the nonlinear model to be used for calculations at the next time step. It is important to note that with the constant gain extended Kalman filter, a linear model is used for gain calculation, and a nonlinear model is used for implementation. Reduced order tuning parameters can also be used in the dynamic tuning process. The outputs from running the constant gain extended Kalman filter on the dynamic data together with the dynamic numerical propulsion system simulation model are an estimate of all output signals, including thrust, as a function of time. Note that the measured thrust is typically not used as a variable in the dynamic calibration process, as it is assumed to be ‘bad.’

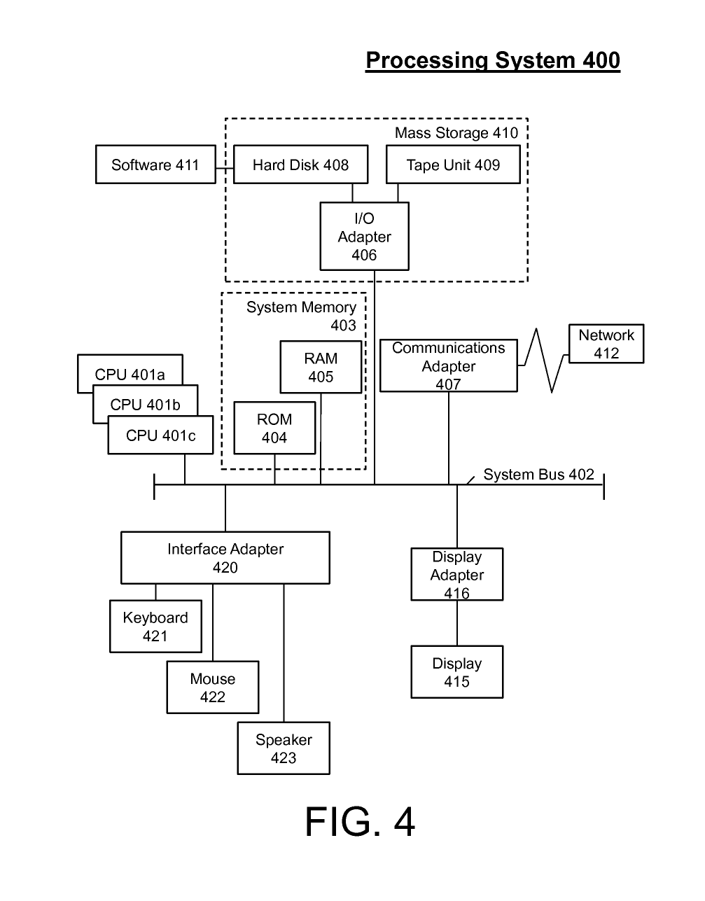

Referring now to FIG. 4, there is shown an embodiment of a processing system 400 for implementing the teachings herein. The processing system 400 can be implemented using a code on-board an aircraft (e.g., by taking data from a control system and calculating and supplying the data into a health monitoring database and/or putting data directly to a cockpit of the aircraft via warning screens). In this way, the processing system can be utilized on-board for ongoing health and engine capability assessment of the aircraft. For instance, the data could come directly from an engine control system or another onboard health and usage data system, and an output would go into a health and usage system or even a cockpit display (e.g., if the result warrants immediate or near-term attention). Then, a calculated dynamic signal can be used to estimate the ‘dynamic response health’, and thus a capability of an engine to be able to start up (or respond) quickly enough when needed is initialized. For example, if a helicopter has 2 engines, and one is off, the processing system 400 can determine if the engine can quickly get to a point where it can cover any overall power loss that the ‘on’ engine experiences from a sudden power loss or other operating change—without the helicopter losing altitude.

The processing system 400 can have one or more central processing units (processors) 401a, 401b, 401c, etc. (collectively or generically referred to as processor(s) 401). The processors 401, also referred to as processing circuits, are coupled via a system bus 402 to system memory 403 and various other components.

The system memory 403 can include read only memory (ROM) 404 and random access memory (RAM) 405. The ROM 404 is coupled to system bus 402 and may include a basic input/output system (BIOS), which controls certain basic functions of the processing system 400. RAM 405 is read-write memory coupled to system bus 402 for use by processors 401. Either of the ROM 404 or the RAM 405 may store the measuring system 150 of FIG. 1 or components thereof.

For example, in the above thrust estimation scheme (e.g., process flow 200), the numerical propulsion system simulation software of the measuring system 150 can be stored on the ROM 404 and executed by the processor 401 to model a gas turbine engine. The numerical propulsion system simulation software can run from text based scripts written in a C++ style format, as further described below, or command line format. Further, the numerical propulsion system simulation software contains many built in features such as engine sub-component models (compressors, turbines, combustors, etc.), internal solvers (e.g. that solve for energy and mass balances), integrators, unit conversions, look-up tables (e.g. for reading compressor maps), design, steady state and transient engine running functions and many other features. Because of the power of the numerical propulsion system simulation software, plus the fact that it ensures physical realism, through mass balances, energy balances, physical properties and component performance limits, a functionality of thrust estimation can be added to the numerical propulsion system simulation scripts themselves.

Examples of the functionality of the thrust estimation in the numerical propulsion system simulation software include the ability to handle some types of tuners and a thrust estimation wrapper code that automatically inserts code in script files to add the necessary features to their model ‘on the fly.’ The functionalities assigned to the numerical propulsion system simulation software and that assigned to the thrust estimation wrapper code that wraps the numerical propulsion system simulation software are listed in TABLE 1 below. Note that all of the preliminary calculations (e.g., gains, data manipulation, optimization, etc.) are performed within the thrust estimation wrapper code. All engine calculations (e.g., steady state and transient engine runs, Kalman filter, etc.) are performed within the numerical propulsion system simulation (NPSS) itself.

TABLE 1
Tasks of Numerical Propulsion System Simulation and Thrust
Estimation Wrapper Code

| Numerical Propulsion System | |
|---|---|
| Simulation | Thrust Estimation Wrapper |
| Built in functionality | Setting of all model inputs |
| Define engine components including | Data mapping of measured data to |
| the gas path, mechanical connections | NPSS variables |
| and flows | Reading measured test cell data |
| Internal solver to ensure flow | Preliminary calculations |
| continuity, energy balances | Creation of all NPSS model |
| Integration of system states | modifying scripts and run files |
| Added functionality | Model calibration using a nonlinear |
| Inclusion of engine health parameters | least squares optimization heuristic |
| Addition of parameter, sensor and | Creation of reduced order tuners for |
| actuator biases | both steady state and dynamic |
| Internal batch running of steady state | calibration |
| model | Model linearization |
| Addition of transient dynamics | Kalman gain calculation |
| Transiently running CGEKF | Displaying model output in tables |
| | and graphs |

FIG. 4 further depicts an input/output (I/O) adapter 406 and a network adapter 407 coupled to the system bus 402. I/O adapter 406 may be a small computer system interface (SCSI) adapter that communicates with a hard disk 408 and/or tape storage drive 409 or any other similar component. I/O adapter 406, hard disk 408, and tape storage drive 409 are collectively referred to herein as mass storage 410. Software 411 for execution on processing system 400 may be stored in mass storage 410. The mass storage 410 is an example of a tangible storage medium readable by the processors 401, where the software 411 is stored as instructions for execution by the processors 401 to perform a method, such as the process flows of FIGS. 2-3. Network adapter 407 interconnects system bus 402 with an outside network 412 enabling processing system 400 to communicate with other such systems. A screen (e.g., a display monitor) 415 is connected to system bus 402 by display adapter 416, which may include a graphics controller to improve the performance of graphics intensive applications and a video controller. For example, the measuring system 150 can through the graphics controller create a graphical user interface to provide a single place to create, test and amend good thrust estimation models, along with visual results along the way (e.g., graphics as well as numbers). That is, due to the overall thrust estimation process (e.g., process flow 200) being complex in terms of the number of inputs and settings that can be used, especially with the flexibility inherent in the numerical propulsion system simulation software and the different measured engine test cell data (number of runs, measured parameters, etc.) that may be available for the analysis. Further, the graphical user interface can include an initialization screen, a steady state calibration tab, and a dynamic state calibration tab.

In the initialization screen, parameters can be set up that will be used in all other parts of the software. Examples of what gets set up on the initialization screen are the links to the Excel spreadsheets (or other data file formats) that contain the steady state and dynamic test cell data and the numerical propulsion system simulation model that will be used. Upon loading the numerical propulsion system simulation model, a graphic of the engine flow path and connections can be automatically created based on how it was defined in a source file. In turn, the graphical user interface can aid in defining the variables of interest, such as providing a mechanism to link health bias variables to corresponding ‘internal’ variables inside the numerical propulsion system simulation model. Any input or output data that will be used by the thrust estimation wrapper code can also be set up by choosing a measured test cell data column description and linking it to the variable inside the numerical propulsion system simulation model corresponding to that measurement.

Another initialization input can be a selection which of a set of steady state points will be used for the steady state calibration optimization process (e.g., block 220). In this way, during the thrust estimation process, points can easily be eliminated that may be pulling the calculations off. For example, if interested in the dynamic thrust at high power, the steady state values at the lowest power may not be utilized, as matching performance in this range through an overall optimization may pull the match off slightly at the higher powers. Also, runs where the test cell engine is in control states that may not be modeled fully (or modeled improperly) in propulsion system simulation may be eliminated.

In the steady state calibration tab, variables (a subset of all those defined in the initiation tab) and weights for the variables (how closely each variable should be matched) are selectable. Linear combinations of variables into any desired ‘reduced order tuners’ can also be linked in the steady state calibration tab. Further, from the steady state calibration tab, the steady state calibration can be run, along with analysis of the results and changes to the calibration until a satisfactory calibration is found.

With respect to the dynamic state calibration tab, the dynamic calibration can be run, along with analysis the results and changes until a satisfactory calibration is found. Further, inputs are supplied for the dynamic thrust estimation. These inputs can include selection of tuner biases, inputs for sensor or actuator first order lags (e.g., that may occur between the measurement and when that parameter affects the engine), inputs for linearization of the model, Kalman filter settings, and reduced order tuners. Also, from the dynamic calibration tab, output graphs can be presented to show time histories of the model inputs (e.g., measured and estimated), model outputs (e.g., measured and estimated), the state tuner derivatives (e.g., shaft speeds), and bias tuners. All data from the graphical user interface can be saved to a file to enable further analysis and plotting.

In one embodiment, adapters 406, 407, and 416 may be connected to one or more I/O buses that are connected to system bus 402 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 402 via an interface adapter 420 and the display adapter 416. A keyboard 421, mouse 422, and speaker 423 can be interconnected to system bus 402 via interface adapter 420, which may include, for example, a Super I/O chip integrating multiple device adapters into a single integrated circuit.

Thus, as configured in FIG. 4, processing system 405 includes processing capability in the form of processors 401, and, storage capability including system memory 403 and mass storage 410, input means such as keyboard 421 and mouse 422, and output capability including speaker 423 and display 415. In one embodiment, a portion of system memory 403 and mass storage 410 collectively store an operating system to coordinate the functions of the various components shown in FIG. 4.

Technical effects and benefits include a measuring system for thrust estimation that computes a clean estimate of the engine dynamic thrust that can be used as a surrogate measurement should the actual test cell thrust measurement be excessively noisy or otherwise unreliable, which can be the case when running various transients in certain test cell settings.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A measuring system for computing a dynamic thrust, the measuring system comprising a processor and a memory storing instructions thereon, the instructions executable by the processor to cause the measuring system to perform:
calibrating of an engine model by utilizing steady state engine data based on multiple operating conditions to produce a calibrated model; and
estimating the dynamic thrust by inputting dynamic state engine data into the calibrated model.

2. The measuring system of claim 1, wherein the calibrating of the engine model is optimized based on a hybrid heuristic optimization algorithm.

3. The measuring system of claim 1, wherein with respect to the calibrating of the engine model the instructions are further executable by the processor to cause the measuring system to perform:
determining by a non-linear least squares heuristic whether an error has converged to a minimum value.

4. The measuring system of claim 3, wherein when the error has not converged to the minimum value, the non-linear least squares heuristic changes at least one selected tuner value to minimize the error.

5. The measuring system of claim 1, wherein with respect to the estimating of the dynamic thrust the instructions are further executable by the processor to cause the measuring system to perform:
dynamic calibration tuning of the calibrated model using a constant gain extended Kalman filter and the dynamic state engine data.

6. A measuring system of claim 1, wherein the measuring system is communicatively coupled to a test cell and receives the steady state engine data and the dynamic state engine data from the test cell.

7. A measuring system of claim 1, wherein the calibrating of the engine model by utilizing the steady state engine data based on the multiple operating conditions to produce the calibrated model comprises additional weighting factors based on which of the multiple operating conditions are being processed by the measuring system.

8. A measuring system of claim 7, further comprising:
performing an analysis to automatically identify which operating point of the multiple operating conditions is the weakest.

9. A measuring system of claim 1, further comprising:
generating optimization parameters and tuner limits across an entire range of uncertainties.

10. A method for computing by a computing device a dynamic thrust, comprising: calibrating, by the computing device, of an engine model by utilizing steady state engine data based on multiple operating conditions to produce a calibrated model; and
estimating, by the computing device, the dynamic thrust by inputting dynamic state engine data into the calibrated model.

11. The method of claim 10, wherein the calibrating of the engine model is optimized based on a hybrid heuristic optimization algorithm.

12. The method of claim 10, further comprising:
determining by a non-linear least squares heuristic whether an error has converged to a minimum value.

13. The measuring system of claim 12, wherein when the error has not converged to the minimum value, the non-linear least squares heuristic changes at least one selected tuner value to minimize the error.

14. The method of claim 10, wherein further comprising:
dynamic calibration tuning of the calibrated model using one of an extended Kalman filter, a constant gain extended Kalman filter, and a set of scheduled constant gain Kalman filters.

15. A method of claim 10, wherein the computing device is communicatively coupled to a test cell and the method further comprises receiving, by the computing device, the steady state engine data and the dynamic state engine data from the test cell.
